(19) United States
(12) Patent Application Publication
(10) Pub. No.: US 2026/0181527 A1
(43) Pub. Date: Jun. 25, 2026

(54) TIMEOUT PERIOD FOR REJECTED AUTHENTICATION REQUESTS

(71) Applicant: Charter Communications Operating, LLC, St. Louis, MO (US)

(72) Inventors: Sushma Sangameswaran, Aurora, CO (US); Laxman Nallani, Parker, CO (US)

(73) Assignee: Charter Communications Operating, LLC, St. Louis, MO (US)

(21) Appl. No.: 18/991,261

(22) Filed: Dec. 20, 2024

(51) Int. Cl. H04W 48/02; H04W 12/06; H04W 12/61

(52) U.S. Cl. CPC H04W 48/02; H04W 12/06; H04W 12/61

(57) ABSTRACT

To avoid being overwhelmed by repeated authentication requests from faulty user equipment, in response to rejecting at least one authentication request from a UE, a wireless network (i) transmits a timeout message to the UE to instruct the UE to refrain from transmitting subsequent authentication requests for a timeout period corresponding to a specified timeout duration and/or (ii) establishes a local timeout period corresponding to the specified timeout duration during which the local network drops subsequent authentication requests received from the UE.

### BACKGROUND

### FIELD OF THE DISCLOSURE

The present disclosure relates to wireless communications and, more specifically but not exclusively, to techniques for handling rejections of authentication requests from wireless devices.

### Description of the Related Art

This section introduces aspects that may help facilitate a better understanding of the disclosure. Accordingly, the statements of this section are to be read in this light and are not to be understood as admissions about what is prior art or what is not prior art.

In order to communicate over and with a wireless network, a wireless device, such as a cell phone, must first be authenticated by the network. To do so, the wireless device (aka user equipment or UE, for short) transmits an authentication request to the network. In response, the network attempts to authenticate the UE and verify that the owner of the UE is authorized to communicate with the network. If so, then the network transmits a positive response to the UE, thereby prompting the UE to associate and begin active communications with the network. Otherwise, the network transmits a negative response (i.e., an authentication rejection message) to the UE indicating that the UE will not be allowed to communicate with the network.

### SUMMARY

In certain circumstances, a software or other problem at a UE can result in the UE continuing to transmit frequent authentication requests to a wireless network in spite of receiving authentication rejection messages from the network. Such frequent, ineffective authentication requests from one or more different UEs have been known to overwhelm the network's ability to process and respond to those and other requests, thereby slowing down and/or inhibiting the network from processing legitimate authentication and other requests from properly operating UEs.

Problems in the prior art are addressed in accordance with the principles of the present disclosure by a wireless network rejecting an authentication request from a UE that is not entitled to communicate with the network and then initiating an appropriate timeout period during which subsequent authentication requests from that UE are either prevented or not fully processed.

In some embodiments, if an authentication request from a UE is rejected by a wireless network, the network then transmits a special timeout message to the UE that instructs the UE to refrain from transmitting any further authentication requests to the network for specified timeout duration and, in response, the UE establishes a corresponding timeout period and refrains from transmitting such requests during that timeout period. In some implementations, the UE is preprogrammed with the specified timeout duration. In other implementations, the timeout duration is explicitly identified in the timeout message.

In other embodiments, if an authentication request from a UE is rejected by a wireless network, the network establishes a timeout period internally, where the network refrains from fully processing subsequent authentication requests received from the UE for the duration of the timeout period.

In either case, the result will be a decrease in the amount of processing required for the network to perform, thereby avoiding - or at least reducing - the inhibition of the network's ability to handle authentication and other requests from properly operating UEs.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified diagram of a wireless network according to certain embodiments of the present disclosure;

FIG. 2 is a flow diagram of processing associated with certain embodiments of the wireless network and the UE of FIG. 1;

FIG. 3 is a flow diagram of processing associated with other embodiments of the wireless network and the UE of FIG. 1; and

FIG. 4 is a simplified hardware block diagram of an example component that can be used to implement any of the components of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

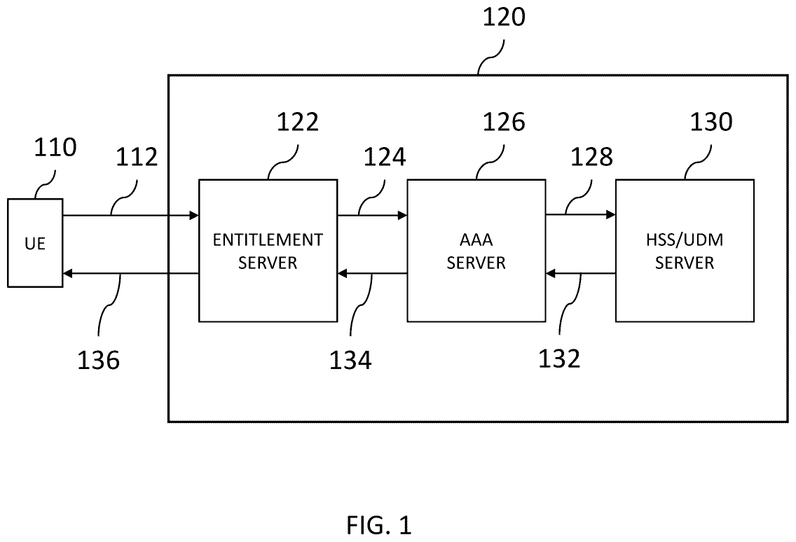

FIG. 1 is a simplified diagram of a wireless network 120 comprising (among other components not shown in FIG. 1) an entitlement server 122, an Authentication, Authorization, and Accounting (AAA) server 126, and an HSS/UDM server 130. Those skilled in the art will understand that the HSS/UDM server 130 may be implemented using either Home Subscriber Server (HSS) technology or Unified Data Management (UDM) technology.

Also shown in FIG. 1 is a wireless device (aka UE) 110, such as (without limitation) a cell phone. Those skilled in the art will understand that the entitlement server 122, the AAA server 126, and the HSS/UDM server 130 of the wireless network 120 are involved in the conventional process of authenticating the UE 110 and authorizing the UE to communicate with the network. In particular, that conventional authentication and authorization process involves the UE 110 transmitting an authentication request to the entitlement server 122, which forwards the authentication request to the AAA server, which, in turn, forwards the authentication request to the HSS/UDM server 130, which determines whether to accept or reject the UE's authentication request. For example, if the owner of the UE 110 is not a current subscriber of the service provider that runs the wireless network 120 (or a current subscriber of a different service provider having a roaming agreement with the network's service provider), then the HSS/UDM server 130 will reject the UE's authentication request. In that case, the HSS/UDM server 130 will transmit a message back to the AAA server 126 indicating that the UE's authentication request is rejected. The AAA server 126 will forward that rejection message to the entitlement server 122, which will, in turn, transmit a rejection message to the UE 110.

Those skilled in the art will understand that different transmission protocols may be used for messaging between the different components in FIG. 1. For example, in some implementations, the messaging between the UE 110 and the entitlement server 122 uses the Hypertext Transfer Protocol Secure (HTTPS) protocol, while the messaging between the entitlement server and the AAA server uses the Diameter Extensible Authentication Protocol (EAP)). If HSS technology is used for the HSS/UDM server 130, then the messaging between the AAA server 126 and the HSS/UDM server 130 may use the Diameter EAP protocol. If UDM technology is used for the HSS/UDM server 130, then the messaging between the AAA server 126 and the HSS/UDM server 130 may use either the HTTPS or HTTP protocol. In these implementations, the entitlement server 122 and/or the AAA server 126 will convert incoming messages in one protocol into corresponding outgoing messages in a different protocol.

Under proper operating conditions, after receiving an authentication rejection message, the UE 110 will take no further automatic action. However, as described above, under some improper operating conditions, the UE 110 will continue to transmit frequent authentication requests to the wireless network 120. To address those situations, according to different embodiments of the present disclosure, the wireless network 120 takes different specific actions.

In certain embodiments, the wireless network 120 keeps track of the number of authentication rejections for each different UE over the most recent period of time corresponding to a specified duration. If and when the number of authentication rejections within that period of time from a given UE reaches a specified threshold level, the wireless network 120 takes specific actions. Note that, in some implementations, the specified threshold level is a single authentication rejection, in which case, the wireless network 120 will take the specific actions as soon as any authentication request is rejected.

In some embodiments, instead of transmitting a conventional authentication rejection message, the specific actions involve the wireless network 120 transmitting a special timeout message to the UE 110 that instructs the UE to refrain from transmitting any further authentication requests during a specified timeout duration of time following the receipt of the timeout message. In some implementations, the timeout duration is explicitly specified in the timeout message. In other implementations, the timeout duration is pre-programmed in the UE 110. In both types of implementation, in response to receiving a timeout message, the UE 110 establishes a timeout period corresponding to the specified timeout duration and refrains from transmitting any further authentication requests to the wireless network 120 for the duration of that timeout period.

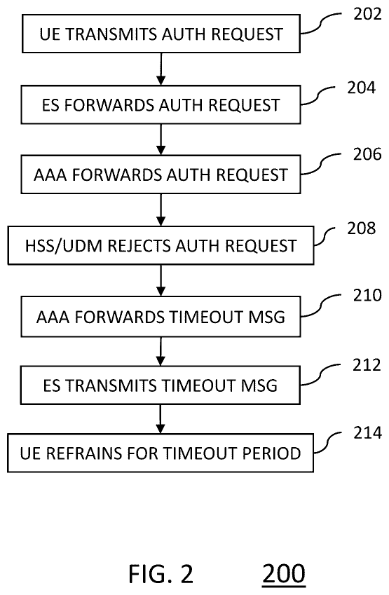

FIG. 2 is a flow diagram of processing 200 associated with certain embodiments of the wireless network 120 and the UE 110 of FIG. 1. In step 202, the UE 110 wirelessly transmits an authentication request 112 to the entitlement server 122. In step 204, the entitlement server 122 forwards the authentication request 124 to the AAA server 126. In step 206, the AAA server 126 forwards the authentication request 128 to the HSS/UDM server 130.

Upon receiving the authentication request 128, the HSS/UDM server 130 determines whether or not to grant the request. In the particular scenario of FIG. 2, in step 208, the HSS/UDM server 130 rejects the authentication request and forwards an authentication rejection message 132 to the AAA server 126. Upon receiving the authentication rejection 132, the AAA server 126 determines that a timeout period is required for the UE. As such, in step 210, the AAA server forwards a special timeout message 134 to the entitlement server 122. In step 212, the entitlement server 122 wirelessly transmits the timeout message 136 to the UE 110. In step 214, in response to receiving the timeout message 136, the UE 110 establishes a corresponding timeout period and refrains from transmitting any further authentication requests to the wireless network 120 for the duration of the timeout period.

Note that the embodiments of FIG. 2 require the UE 110 to be programmed or otherwise configured to handle the special timeout messages.

In other embodiments, the wireless network 120 transmits a conventional authentication rejection message to the UE 110 and also takes specific actions to prevent subsequent authentication requests received from the UE during an established timeout period of a specified timeout duration from being fully processed. In some implementations, the timeout period is established and enforced locally by the entitlement server 122, which keeps track of the timeout periods for the different UEs, recognizes when an authentication request is received from a UE that is currently subject to a timeout period, and drops that authentication request. In particular, dropping an authentication request involves (i) not forwarding the authentication request to the AAA server 126 and (ii) not transmitting an authentication rejection message back to the UE.

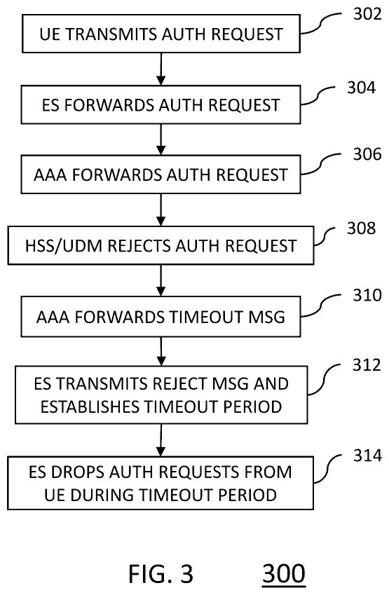

FIG. 3 is a flow diagram of processing 300 associated with these other embodiments of the wireless network 120 and the UE 110 of FIG. 1. Steps 302-310 of FIG. 3 are the same as steps 202-210 of FIG. 2. In step 312, instead of transmitting a special timeout message to the UE 110, as in step 212 of FIG. 2, the entitlement server 122 transmits a conventional authentication rejection message 136 to the UE 110 and establishes a local timeout period for that UE. If and when the UE 110 transmits any subsequent authentication requests 112 to the entitlement server 122 during the local timeout period, in step 314, the entitlement server 122 drops those authentication requests.

Note that the embodiments of FIG. 3 do not impact the programming or other configuration of the UE 110.

In other implementations, instead of the entitlement server 122 establishing and enforcing the timeout period, the timeout period is established and enforced locally by the AAA server 126, which keeps track of the timeout periods for the different UEs, recognizes when an authentication request is received from a UE that is currently subject to a timeout period, and drops that authentication request. In this case, dropping an authentication request involves (i) not forwarding the authentication request to the HSS/UDM server 130 and (ii) not transmitting an authentication rejection message back to the UE via the entitlement server 122.

Those skilled in the art will understand that, for these latter implementations, the processing may be the same as the processing 300 of FIG. 3 except that, instead of the entitlement server 122, the AAA server 126 establishes the local timeout period and drops subsequent authentication requests received by the AAA server from the UE 110 via the entitlement server during the local timeout period.

Note that, in some embodiments, the wireless network 120 performs both step 212 of FIG. 2 and steps 312-314 of FIG. 3. In those embodiments, the wireless network 120 establishes and imposes a timeout period locally whether or not the UE 110 establishes and imposes its own timeout period.

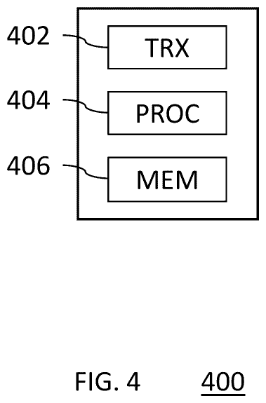

FIG. 4 is a simplified hardware block diagram of an example component 400 that can be used to implement any of the components 110, 122, 126, and 130 of FIG. 1. As shown in FIG. 4, the component 400 includes (i) suitable communication hardware (e.g., wireless, wireline, and/or optical transceivers (TRX)) 402 that supports communications with other components, (ii) one or more processors (e.g., CPU and/or GPU microprocessors) 404 that control the operations of the component 400 and/or process data within the component 400, and (iii) one or more memories (e.g., RAM, ROM) 406 that store code executed by the processors 404 and/or data generated and/or received by the component 400.

Although embodiments have been described in the context of the wireless network 120, which comprises the entitlement server 122, the AAA server 126, and the HSS/UDM server 130, those skilled in the art will understand that the disclosure can be implemented in the context of other wireless networks having other types of components that handle authentications requests from wireless devices.

In certain embodiments, the present disclosure is a wireless network comprising a memory and at least one processor, coupled to the memory and operative to cause the wireless network to (i) receive at least one authentication request from a user equipment (UE); (ii) determine whether to accept or reject the at least one authentication request; and (iii) upon rejecting a specified number of authentication requests, at least one of (i) transmit a timeout message to the UE to instruct the UE to refrain from transmitting subsequent authentication requests for a timeout period corresponding to a specified timeout duration and (ii) establish a local timeout period corresponding to the specified timeout duration during which the local network drops the subsequent authentication requests received from the UE.

In at least some of the above embodiments, the specified number is one.

In at least some of the above embodiments, the wireless network is configured to transmit the timeout message to the UE to instruct the UE to refrain from transmitting the subsequent authentication requests for the timeout period corresponding to the specified timeout duration.

In at least some of the above embodiments, the timeout duration is explicitly specified in the timeout message.

In at least some of the above embodiments, the wireless network comprises an entitlement server, an Authentication, Authorization, and Accounting (AAA) server, and a Home Subscriber Server/Unified Data Management (HSS/UDM) server. The entitlement server is configured to receive and forward the authentication request from the UE to the AAA server. The AAA server is configured to receive and forward the authentication request from the entitlement server to the HSS/UDM server. The HSS/UDM server is configured to receive and determine whether to accept or reject the authentication request and, upon determining to reject the authentication request, forward an authentication rejection to the AAA server. The AAA server is configured to (i) receive the authentication rejection from the HSS/UDM server and (ii) generate and forward the timeout message to the entitlement server. The entitlement server is configured to transmit the timeout message to the UE.

In at least some of the above embodiments, the wireless network is configured to establish the local timeout period corresponding to the specified timeout duration during which the wireless network drops the subsequent authentication requests received from the UE.

In at least some of the above embodiments, the wireless network comprises an entitlement server, a AAA server, and an HSS/UDM server. The entitlement server is configured to receive and forward the authentication request from the UE to the AAA server. The AAA server is configured to receive and forward the authentication request from the entitlement server to the HSS/UDM server. The HSS/UDM server is configured to receive and determine whether to accept or reject the authentication request and, upon determining to reject the authentication request, forward an authentication rejection to the AAA server. The AAA server is configured to receive the authentication rejection from the HSS/UDM server, wherein one of the AAA server and the entitlement server is configured to establish and enforce the local timeout period.

In certain embodiments, the present disclosure is user equipment (UE) for a wireless network. The UE comprises a memory and at least one processor, coupled to the memory and operative to cause the UE to (i) transmit an authentication request to the wireless network; (ii) receive a timeout message in response to the authentication request; (iii) establish a timeout period based on a specified timeout duration; and (iv) refrain from transmitting any subsequent authentication requests to the wireless network during the timeout period.

In at least some of the above embodiments, the timeout duration is explicitly specified in the timeout message.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A wireless network comprising:
a memory; and
at least one processor, coupled to the memory and operative to cause the wireless network to:
receive at least one authentication request from a user equipment (UE);
determine whether to accept or reject the at least one authentication request; and
upon rejecting a specified number of authentication requests, at least one of (i) transmit a timeout message to the UE to instruct the UE to refrain from transmitting subsequent authentication requests for a timeout period corresponding to a specified timeout duration and (ii) establish a local timeout period corresponding to the specified timeout duration during which the local network drops the subsequent authentication requests received from the UE.

2. The wireless network of claim 1, wherein the specified number is one.

3. The wireless network of claim 1, wherein the wireless network is configured to transmit the timeout message to the UE to instruct the UE to refrain from transmitting the subsequent authentication requests for the timeout period corresponding to the specified timeout duration.

4. The wireless network of claim 3, wherein the timeout duration is explicitly specified in the timeout message.

5. The wireless network of claim 3, wherein the wireless network comprises an entitlement server, an Authentication, Authorization, and Accounting (AAA) server, and a Home Subscriber Server/Unified Data Management (HSS/UDM) server, wherein:
the entitlement server is configured to receive and forward the authentication request from the UE to the AAA server;
the AAA server is configured to receive and forward the authentication request from the entitlement server to the HSS/UDM server;
the HSS/UDM server is configured to receive and determine whether to accept or reject the authentication request and, upon determining to reject the authentication request, forward an authentication rejection to the AAA server;
the AAA server is configured to (i) receive the authentication rejection from the HSS/UDM server and (ii) generate and forward the timeout message to the entitlement server; and
the entitlement server is configured to transmit the timeout message to the UE.

6. The wireless network of claim 1, wherein the wireless network is configured to establish the local timeout period corresponding to the specified timeout duration during which the wireless network drops the subsequent authentication requests received from the UE.

7. The wireless network of claim 6, wherein the wireless network comprises an entitlement server, a AAA server, and an HSS/UDM server, wherein:
the entitlement server is configured to receive and forward the authentication request from the UE to the AAA server;
the AAA server is configured to receive and forward the authentication request from the entitlement server to the HSS/UDM server;
the HSS/UDM server is configured to receive and determine whether to accept or reject the authentication request and, upon determining to reject the authentication request, forward an authentication rejection to the AAA server; and
the AAA server is configured to receive the authentication rejection from the HSS/UDM server, wherein one of the AAA server and the entitlement server is configured to establish and enforce the local timeout period.

8. A method for a wireless network, the method comprising the wireless network:
receiving at least one authentication request from a user equipment (UE);
determining whether to accept or reject the at least one authentication request;
upon rejecting a specified number of authentication requests, at least one of (i) transmitting a timeout message to the UE to instruct the UE to refrain from transmitting subsequent authentication requests for a timeout period corresponding to a specified timeout duration and (ii) establishing a local timeout period corresponding to the specified timeout duration during which the local network drops the subsequent authentication requests received from the UE.

9. The method of claim 8, wherein the specified number is one.

10. The method of claim 8, wherein the wireless network transmits the timeout message to the UE to instruct the UE to refrain from transmitting the subsequent authentication requests for the timeout period corresponding to the specified timeout duration.

11. The method of claim 10, wherein the timeout duration is explicitly specified in the timeout message.

12. The method of claim 10, wherein the wireless network comprises an entitlement server, a AAA server, and an HSS/UDM server, wherein:
the entitlement server receives and forwards the authentication request from the UE to the AAA server;
the AAA server receives and forwards the authentication request from the entitlement server to the HSS/UDM server;
the HSS/UDM server receives and determines whether to accept or reject the authentication request and, upon determining to reject the authentication request, forwards an authentication rejection to the AAA server;
the AAA server (i) receives the authentication rejection from the HSS/UDM server and (ii) generates and forwards the timeout message to the entitlement server; and
the entitlement server transmits the timeout message to the UE.

13. The method of claim 8, wherein the wireless network establishes the local timeout period corresponding to the specified timeout duration during which the wireless network drops the subsequent authentication requests received from the UE.

14. The method of claim 13, wherein the wireless network comprises an entitlement server, a AAA server, and an HSS/UDM server, wherein:
the entitlement server receives and forwards the authentication request from the UE to the AAA server;
the AAA server receives and forwards the authentication request from the entitlement server to the HSS/UDM server;
the HSS/UDM server receives and determines whether to accept or reject the authentication request and, upon determining to reject the authentication request, forwards an authentication rejection to the AAA server; and
the AAA server receives the authentication rejection from the HSS/UDM server, wherein one of the AAA server and the entitlement server establishes and enforces the local timeout period.

15. A user equipment (UE) for a wireless network, the UE comprising:
a memory; and
at least one processor, coupled to the memory and operative to cause the UE to:
transmit an authentication request to the wireless network;
receive a timeout message in response to the authentication request;
establish a timeout period based on a specified timeout duration; and
refrain from transmitting any subsequent authentication requests to the wireless network during the timeout period.

16. The UE of claim 15, wherein the timeout duration is explicitly specified in the timeout message.

17. A method for a user equipment (UE) for a wireless network, the method comprising the UE:
transmitting an authentication request to the wireless network;
receiving a timeout message in response to the authentication request;
establishing a timeout period based on a specified timeout duration; and
refraining from transmitting any subsequent authentication requests to the wireless network during the timeout period.

18. The method of claim 17, wherein the timeout duration is explicitly specified in the timeout message.
